(19) United States
(12) Patent Application Publication
(10) Pub. No.: US 2011/0191377 A1
(43) Pub. Date: Aug. 4, 2011

(54) SOFTWARE INSTALLATION AUTHORIZATION SYSTEM

(76) Inventor: ROBERT ALLEN WILSON, SHAWNEE, KS (US)

(21) Appl. No.: 13/007,418

(22) Filed: Jan. 14, 2011

Related U.S. Application Data
(63) Continuation-in-part of application No. 11/611,877, filed on Dec. 17, 2006, now abandoned.

(51) Int. Cl. G06F 17/30

(52) U.S. Cl. 707/783; 707/E17.005

(57) ABSTRACT

A data authorization system and method of authorizing access to data stored on a data storage medium are provided. The data authorization system utilizes a readable and writeable data storage medium that includes a private area and a public area, a compiled scripted database located in the private area, a file located in the public area that directs a computer operating system to activate the compiled scripted database, and a container field within the compiled scripted database for holding data and only allowing access to the data by the operating system when certain preset parameters stored in said compiled scripted database have been met.

### CROSS-REFERENCE TO RELATED APPLICATION

This is a continuation-in-part of U.S. patent application Ser. No. 11/611,877 filed Dec. 17, 2006, the entire disclosure of which is incorporated herein by reference.

### FIELD OF THE INVENTION

The present invention relates to software installation media, and more particularly to software installation via USB flash drives.

### BACKGROUND OF THE INVENTION

Software Developers have always struggled with the issue of unauthorized installations of their software, better known as Piracy. Currently, Developers sell their software on a CD along with a printed installation code. The purchaser must use this code in order to complete the installation and activate the software. It is the hopes of each Developer that the end-user will only install the software on one computer. But the end-user can make copies of the CD and installation code and then gives them away or sells as many copies as he or she chooses. These copies will install the software on other computers. Software Developers are cheated out of the sales price of each of these pirated copies.

### SUMMARY OF THE INVENTION

In accordance with the aspects of the present invention the Software Installation Authorization System (SIAS) ensures that software is installed only in the computer for which it was intended is disclosed. It accomplishes this through the use of a compiled and scripted database hidden in a private partition on a USB Flash drive.

When the USB Flash drive is inserted into the computer for the first time it gathers unique and irrefutable identifying information about the computer and then releases the software installer from a container field in the database. Upon subsequent insertions the database gathers the same identifying information and compares it to the previously gather information before releasing the software installer.

If the information matches the software installer is released and installed. If the information does not match then the process is halted and the user is informed that the process will not proceed.

The software developer can assign an unlimited number of preset conditions into the database before its distribution. Examples of these conditions are: 1) Total number of installs, 2) Total number of computers to receive installs, etc.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is a perspective view of the process flow for the Software Developer's Interface.

FIG. 2 is a plan view of a USB Flash Drive along with the two Partitions and associated files.

FIG. 3 is a plan view of the components of the SAIS Database.

FIG. 4 is a perspective view of the process flow within the SAIS upon initial insertion of the USB Flash drive into a computer.

FIG. 5 is a perspective view of the process flow within the SAIS upon subsequent insertion of the USB Flash drive into a computer.

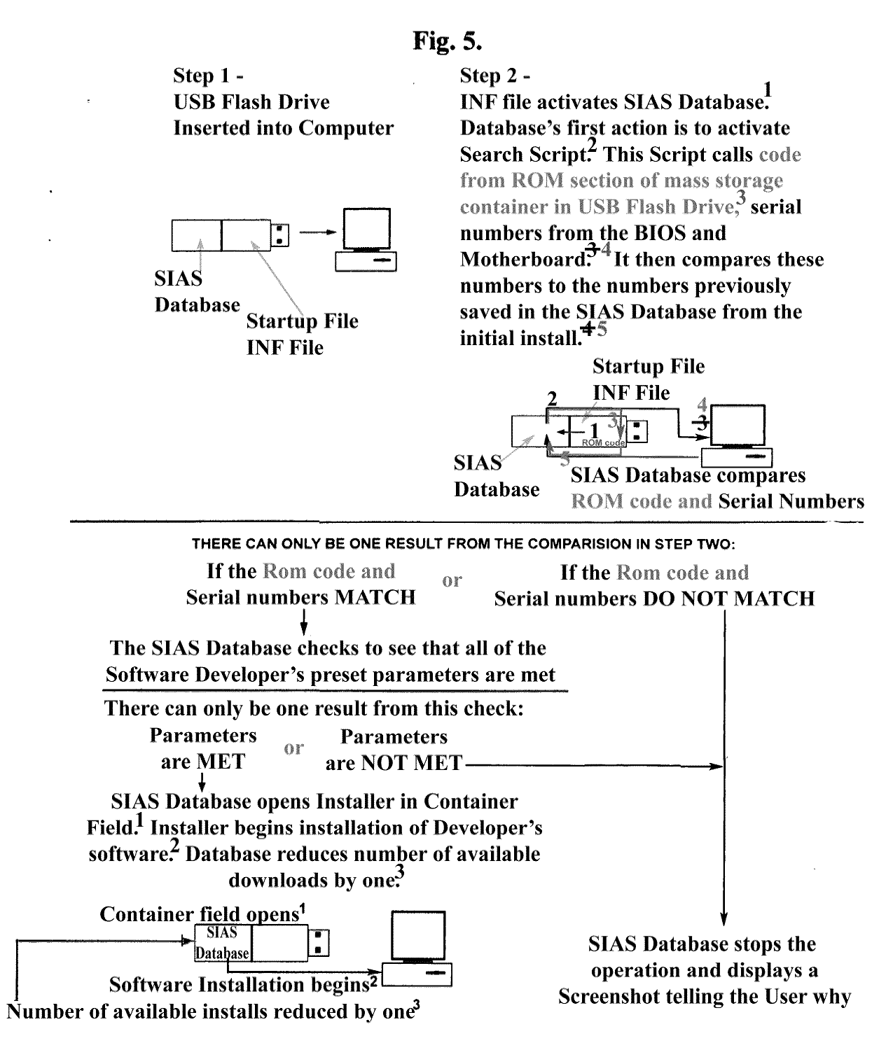

### DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

A preferred embodiment of this invention, the Software Installation Authorization System (SIAS), is comprised of a compiled scripted Database on a partitioned USB Flash Drive. This drive has two partitions, one public and one private. The Private partition and its contents are not viewable or accessible by the Operating System (OS) or end users. This partition cannot be copied. The public partition contains two files and is viewable. The first is the starter file associated with all USB Flash drives. This file installs drivers in the operating system to enable the computer to recognize the USB Flash Drive as a viable drive. The second file is an INF auto start file. The INF file automatically runs upon insertion of the USB flash Drive into a USB port in a computer. It directs the computer's OS to activate a file in the Private partition on the USB Flash Drive. This activated file is a compiled scripted Database. Every time this database is activated the first thing it does is run a search script that retrieves data associated with the USB Flash Drive. It then compares this data to existing data in the Database in the Private Partition of the USB Flash Drive. It does this to verify that an identification code exists on the USB mass storage controller device in ROM (read only memory). This code must be previously embedded into the ROM of the mass storage controller during the manufacturing process of the USB Flash Drive. When and if this code is located, it is compared to a code value that exists in the database. If there is no code or the code does not match the value in the database, then the database will terminate the software installation process. In preferred embodiments, the code is a code that identifies the specific USB Flash Drive and is unique to each individual USB Flash Drive. In one preferred embodiment, the code is a 50 character alpha-numeric code that is sequentially generated and assigned to USB Flash Drives as they are manufactured. Nevertheless, it will be appreciated that alternative code structures and generation or value assignment mechanisms may be utilized without departing from the spirit and scope of the instant invention

Upon successful verification and validation of the code, the Database script collects the computer's BIOS serial number and the Motherboard's serial number, and then saves this data in the Database in the Private Partition of the USB Flash Drive. These numbers are unique and when used in combination with each other absolutely identifies the computer in which they are installed as being unique. This database runs every time the USB Flash Drive is inserted.

During the first installation the BIOS and Motherboard serial number data is retrieved and then written to the database. This data is retained in the database and used to validate future installs. The Database then opens a Container Field, which holds a Software Installer file. When opened, this Installer begins the installation of the Software Developer's software on the computer's hard drive.

During subsequent insertions of the USB Flash Drive, the Database will again gather the USB Flash drive identification code from the ROM section of the mass storage controller along with the computer's BIOS and Motherboard serial numbers. If there is no identification code or the code does not match the value in the database, then the database will terminate the software installation process.

It will then compare the computer's BIOS and Motherboard serial numbers to the previously gathered numbers, which have been saved in the database. If the serial numbers from the subsequent installation match the BIOS and Motherboard's serial numbers from the initial installation, then the Database will proceed to make sure that all of the Software Developer's preset parameters have been met. If they have been met then the Database will open the container field and the software installer inside will activate and begin to install the Software Developer's software. If the serial number do not match, or the Developer's parameters are not met, then a display screen tells the user that the installation will not be allowed and the process terminates. Some examples of Developer parameter controls are: 1.) Total number of installs, 2.) Total number of re-installs.

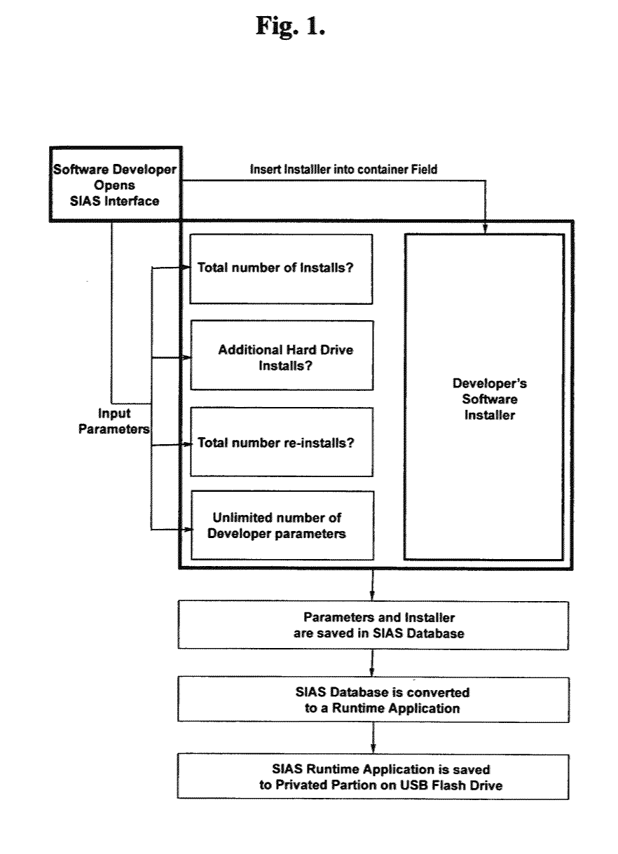

Referring to FIG. 1 a process flow for the Software Developer's Interface of an embodiment of the invention is shown. The Software Developer's Interface of a preferred embodiment allows a Software Developer to set certain installation parameters (such as total number of installs, total number of reinstalls, etc.) and to load the software/data that is to be installed (or accessed) into the Container field of the database. When the Software Developer has 1.) Set installation parameters and, 2.) Loaded his installer into the Container, the Developer converts the database into a runtime application, better known as an executable program. It cannot be altered at this point but it can run when called upon by the INF file. This module is saved to the private partition of the USB Flash drive and becomes the below referenced Third Module.

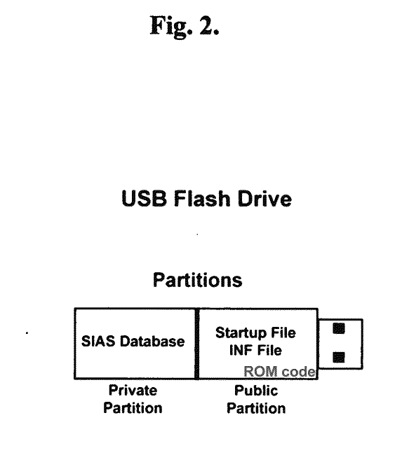

The second module of the SIAS is a partitioned USB Flash drive (FIG. 2). This drive has two partitions; a public partition and a private partition. The public partition contains two files; a starter file and an INF file. The Starter file contains the driver instructions needed for the computer's OS to recognize the USB Flash Drive as an available drive. The INF file is an auto run file and it runs immediately upon insertion of the USB Flash Drive into the computer. This INF file directs the computer's OS to open the SIAS's Database that is located in the private partition on the USB Flash Drive.

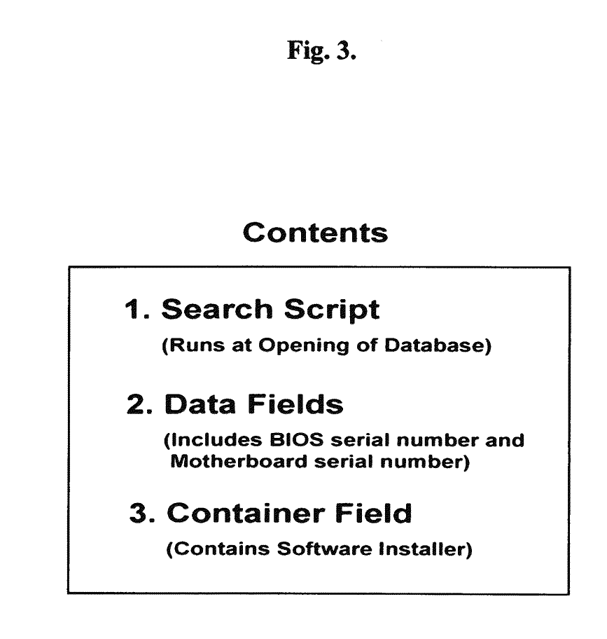

The third module of the SIAS is the SIAS database (FIG. 3). This database is located on the USB flash Drive's private partition, which is not accessible and is not viewable from the computer's OS. The Database has a startup script, multiple Data Fields, and one Container Field. The script is a search script that calls for two things; a code from the ROM section of the mass storage controller, and the computer's BIOS and Motherboard serial numbers. The Database can have multiple data fields. Three of the Data Fields are: 1.) ROM code value, 2.) BIOS serial number and 3.) Motherboard Serial Number. The Container Field is where the Software Developer's installation package is stored.

In a preferred embodiment, the ROM code value is stored in the Database during manufacture or initial setup of the SIAS database, which is performed prior to delivery to the Software Developer. Preferably, in such an embodiment, the ROM code value is obtained through the use of a programming application that pulls the value directly from the identification code that is embedded in the ROM and assigns (or stores) the value to the Data Field. Also preferably, in such an embodiment, the Software Developer's Interface does not allow the Software Developer to manipulate the ROM code value that has been stored in the Database; however, the Software Developer's Interface does allow the Software Developer to set other parameters within Data Fields such as number of installs, number of reinstalls, etc.

When this database opens, its first operation is to execute a script. A script is a series of instructions or commands that are executed in a specific order. This script runs a command that calls for the identification code from the ROM section of the mass storage controller, the computer's BIOS serial number and Motherboard serial number. When the Database script acquires serial numbers then the computer saves that data to the SIAS database.

If this is the first insertion of the USB Flash Drive into a computer and the ROM code verified and validated, the serial numbers data is written to the database and the database opens the Container field. The Software Developer's installer activates and installs the software on the computer's hard drive.

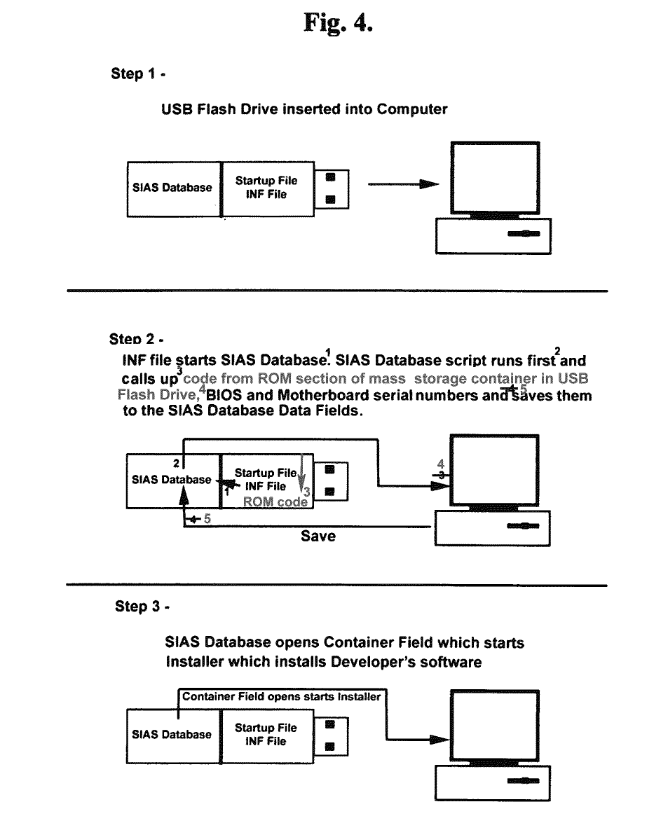

After its initial install, (FIG. 4) every time the USB Flash Drive is inserted into a computer the SIAS's Database will call for the code from the ROM section of the mass storage controller, the BIOS and the Motherboard serial numbers from the computer and then check it for an exact match against the respective values previously stored in its database. If the match is exact and the Developer presets are met, then validation has occurred. If validation has occurred then the Database will open the Container field initiating the installation of the Developer's software. The Database will then reduce, by one, the total allowable installations set by the Software Developer in the database. If there is no match then validation does not occur and the Database will display a screen telling the user that the install will not take place and terminates the entire process.

This process will occur each time the USB Flash Drive is inserted until the total number of installs preset by the Developer is reduced to zero. Upon depletion of available installations the Database will display a notice that no more installations will Occur.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

1. A data authorization system comprising:
a readable and writeable data storage medium, said data storage medium including a private writeable area that is not accessible by an operating system of a computer in which said storage medium is inserted or by an end user of the system, a public area that is accessible by said operating system, and an identification code embedded in read-only memory of said data storage medium;
a compiled scripted database located in said private area of said data storage medium;
a file located in said public area that directs said operating system to activate said compiled scripted database;
a data field within said compiled scripted database in which a value for said identification code is stored; and
a container field within said compiled scripted database for holding data and only allowing access to said data by said operating system when preset parameters stored in said compiled scripted database have been met, wherein one of said preset parameters is that said stored value matches the identification code embedded within the read-only memory of the data storage medium.

2. The data authorization system as claimed in claim 1 wherein said data is a software installation package.

3. The data authorization system as claimed in claim 1 wherein said data storage medium is a USB Flash Drive.

4. The data authorization system as claimed in claim 3 wherein said private area is a private partition of said USB Flash Drive and wherein said public area is a public partition of said USB Flash Drive.

5. The data authorization system as claimed in claim 4 wherein said file is an INF file that automatically runs upon insertion of said USB Flash Drive into a USB port of the computer.

6. The data authorization system as claimed in claim 1 wherein said private area is a private partition of said data storage medium and wherein said public area is a public partition of said data storage medium.

7. The data authorization system as claimed in claim 1 wherein said file is an INF file that automatically runs upon insertion of said data storage medium into the computer.

8. The data authorization system as claimed in claim 1 wherein said compiled scripted database further includes a startup script and data fields.

9. The data authorization system as claimed in claim 8 wherein said startup script collects unique information to identify the computer.

10. The data authorization system as claimed in claim 9 wherein said unique information is compared to information previously stored in said compiled scripted database.

11. The data authorization system as claimed in claim 9 wherein said unique information is written to said compiled scripted database.

12. The data authorization system as claimed in claim 1 wherein said identification code embedded in read-only memory of said data storage medium is located in said public area.

13. A method of authorizing access to data stored on a data storage medium, said method comprising the steps of:
storing deliverable data within a container field of a compiled scripted database located in a private area of the data storage medium;
storing an identification code value within a data field of said compiled scripted database;
embedding an identification code within read-only memory of the data storage medium;
running a file located in a public area of the data storage medium after insertion of the data storage medium into a computer;
activating said compiled scripted database through direction of said file;
determining whether preset parameters stored in said compiled scripted database have been met, wherein one of said preset parameters is an identification code value within said data field that matches the identification code embedded within the read-only memory of the data storage medium; and
opening said container field of said compiled scripted database only if said preset parameters have been met.

14. The method as claimed in claim 13 wherein said opening step comprises delivering said stored deliverable data to the computer.

15. The method as claimed in claim 14 wherein said delivering step comprises installing a software package on the computer.

16. The method as claimed in claim 13 further comprising the step of collecting information unique to the computer and comparing said information to information stored in said compiled scripted database.

17. The method as claimed in claim 13 further comprising the step of collecting information unique to the computer and storing said information in said compiled scripted database.

18. The method as claimed in claim 13 wherein said data is a software installation package and further comprising the step of installing said software on the computer.

19. The method as claimed in claim 13 wherein said data storage medium is a USB Flash Drive.

20. The method as claimed in claim 19 wherein said private area is a private partition of said USB Flash Drive and wherein said public area is a public partition of said USB Flash Drive.

21. The method as claimed in claim 19 wherein said file is an INF file that automatically runs upon insertion of said USB Flash Drive into a USB port of the computer.

22. The method as claimed in claim 13 wherein said private area is a private partition of said data storage medium and wherein said public area is a public partition of said data storage medium.
